(19) United States
(12) Patent Application Publication
(10) Pub. No.: US 2024/0361793 A1
(43) Pub. Date: Oct. 31, 2024

(54) FAST TRANSIENT LINEAR REGULATOR

(71) Applicant: Monolithic Power Systems, Inc., Kirkland, WA (US)

(72) Inventors: Po-Hsien Huang, New Taipei City (TW); Bor-Tsang Hwang, New Taipei City (TW); Yu-Huei Lee, New Taipei City (TW)

(21) Appl. No.: 18/648,086

(22) Filed: Apr. 26, 2024

Related U.S. Application Data
(60) Provisional application No. 63/462,677, filed on Apr. 28, 2023.

(51) Int. Cl. G05F 1/575; G05F 1/565

(52) U.S. Cl. CPC G05F 1/575; G05F 1/565

(57) ABSTRACT

A linear regulator includes a pass element, an error amplifier, and a miller compensation circuit. The error amplifier is configured to provide an error signal to the control terminal of the pass element in response to a reference voltage and a feedback voltage. The error amplifier includes a current mirror stage and a first stage. The current mirror stage is configured to receive the input voltage. The first stage is configured to provide a first current signal to a first terminal of the current mirror stage in response to the reference voltage, and provide a second current signal to a second terminal of the current mirror stage in response to the feedback voltage. The miller compensation circuit is coupled between the second terminal of the pass element and the error amplifier. The miller compensation circuit is configured to control the first current signal.

### CROSS-REFERENCE TO RELATED APPLICATION(S)

The present application claims the benefit of and priority to a U.S. Provisional Patent Application Ser. 63/462,677 filed Apr. 28, 2023, which is hereby incorporated fully by reference into the present application.

### TECHNICAL FIELD

The present disclosure relates generally to power circuits, and more particularly but not exclusively to linear regulator circuits.

### BACKGROUND OF THE INVENTION

Linear regulator circuits such as low dropout (LDO) regulator circuits have been used in many applications. Typically, an LDO regulator circuit includes a pass element to connect between the input source and the output node. An error amplifier compares a reference voltage and the feedback signal and control the pass element to regulate the output voltage. Here, the LDO regulator circuit acts as a variable resistor to maintain output voltage level. The balance among parameters such as quiescent current, transient response, and the total occupied area are important for the LDO circuit design.

### SUMMARY OF THE INVENTION

According to an embodiment of the present disclosure, a linear regulator circuit is provided. The linear regulator includes a pass element, an error amplifier, and a miller compensation circuit. The pass element has a first terminal, a second terminal and a control terminal. The first terminal of the pass element is configured to receive an input voltage, and the second terminal of the pass element is configured to provide an output voltage. The error amplifier is configured to provide an error signal to the control terminal of the pass element in response to a reference voltage and a feedback voltage representing the output voltage. The error amplifier includes a current mirror stage and a first stage. The current mirror stage is configured to receive the input voltage. The first stage is coupled to the current mirror stage. The first stage is configured to provide a first current signal to a first terminal of the current mirror stage in response to the reference voltage, and provide a second current signal to a second terminal of the current mirror stage in response to the feedback voltage. The miller compensation circuit is coupled between the second terminal of the pass element and the error amplifier. The miller compensation circuit is configured to control the first current signal.

According to another embodiment of the present disclosure, a linear regulator circuit is provided. The linear regulator includes a pass element, an error amplifier, and a buffer. The pass element has a first terminal, a second terminal and a control terminal. The first terminal of the pass element is configured to receive an input voltage, and the second terminal of the pass element is configured to provide an output voltage. The error amplifier is configured to provide an error signal in response to a reference voltage and a feedback voltage representing the output voltage. The buffer is configured to provide a control signal to the control terminal of the pass element in response to the error signal. The buffer includes a first transistor, a second transistor and a current source. The first transistor has a first terminal, a second terminal and a control terminal. The control terminal of the first transistor is configured to receive the error signal, and the first terminal of the first transistor is coupled to the control terminal of the pass element. The second transistor has a first terminal, a second terminal and a control terminal. The control terminal of the second transistor is coupled to the second terminal of the first transistor, and the second terminal of the second transistor is coupled to the control terminal of the pass element. The current source is coupled in series with the first transistor, and is configured to provide a current signal to the first transistor.

According to yet another embodiment of the present disclosure, a linear regulator circuit is provided. The linear regulator includes a pass element, an error amplifier, a buffer, a feed-forward loading stage, and a miller compensation circuit. The pass element has a first terminal, a second terminal and a control terminal. The first terminal of the pass element is configured to receive an input voltage, and the second terminal of the pass element is configured to provide an output voltage. The error amplifier includes a differential pair configured to provide a first current signal at a first output terminal in response to a reference voltage and provide a second current signal at a second output terminal in response to a feedback voltage representing the output voltage. The error amplifier is configured to provide an error signal in response to the reference voltage and the feedback voltage. The buffer is configured to provide a control signal to the control terminal of the pass element in response to the error signal. The feed-forward loading stage is coupled between the error amplifier and the second terminal of the pass element. The feed-forward loading stage is configured to adjust a loading current of the pass element. The miller compensation circuit is coupled between the second terminal of the pass element and the error amplifier. The pass element is controlled in response to the control signal via a first feedback path. The first feedback path starts from the second current signal flowing through the second output terminal of the differential pair, through a second current mirror coupled to the second output terminal of the differential pair, and through the buffer to the control terminal of the pass element.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 is a schematic block diagram of an LDO circuit in accordance with an embodiment of the present disclosure.

FIG. 2 is a schematic circuit diagram of an LDO circuit in accordance with an embodiment of the present disclosure.

FIG. 3 is a schematic circuit diagram of an LDO circuit in accordance with another embodiment of the present disclosure.

FIG. 4 is a schematic circuit diagram of an LDO circuit in accordance with yet another embodiment of the present disclosure.

FIG. 5 is a schematic circuit diagram of an LDO circuit in accordance with yet another embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

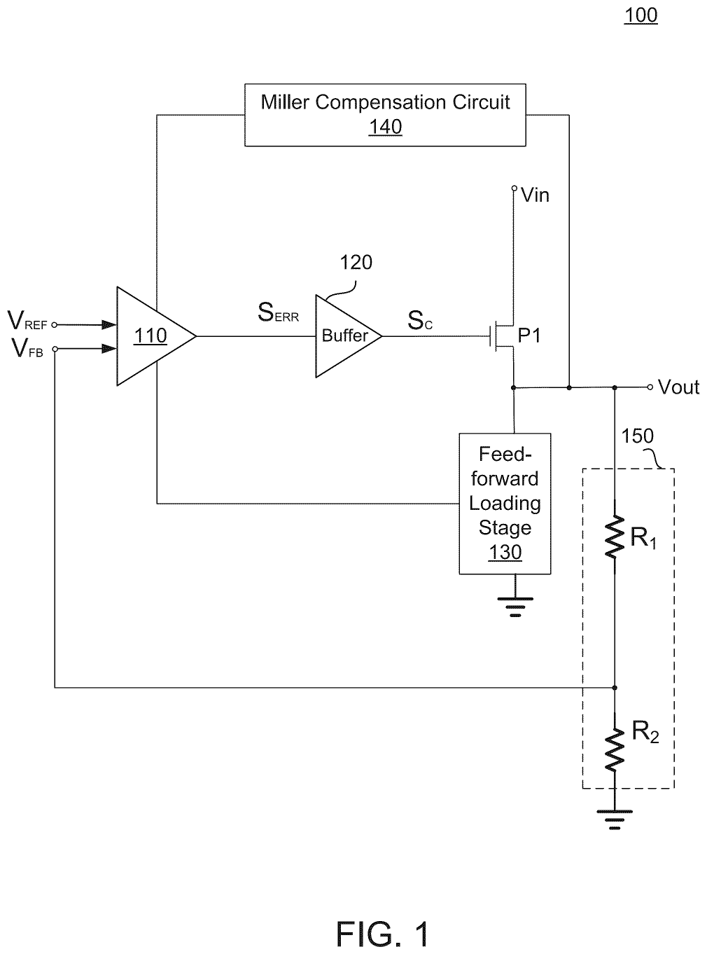

FIG. 1 is a schematic block diagram of an LDO circuit 100 in accordance with an embodiment of the present disclosure. The LDO circuit 100 includes an error amplifier 110, a pass element P1 and a feedback circuit 150. The pass element P1 is coupled between an input node Vin and an output node Vout. The error amplifier 110 is configured to receive a reference voltage V_{REF} and a feedback voltage V_{FB} representing the output voltage at the output node Vout, and provide an error signal S_{ERR} to the control terminal (e.g., gate) of the pass element P1 in response to the reference voltage V_{REF} and the feedback voltage V_{FB}.

In one embodiment, the LDO circuit 100 further includes a buffer 120. The buffer 120 is coupled to the error amplifier 110. The buffer 120 is configured to receive the error signal S_{ERR}, and provide a control signal Sc to the control terminal (e.g., gate) of the pass element P1 in response to the error signal S_{ERR}.

In another embodiment, the LDO circuit 100 further includes a feed-forward loading stage 130. The feed-forward loading stage 130 is coupled between the output node Vout and the error amplifier 110. The feed-forward loading stage 130 is configured to adjust a loading current of the pass element P1 to enhance the transient response. When the transient event happens, the feed-forward stage 130 increases or decreases the loading current based on the information from the error amplifier 110 to stabilize the output voltage at the output node Vout.

In some embodiments, the LDO circuit 100 further includes a miller compensation circuit 140. The miller compensation circuit 140 is configured to provide miller compensation between the error amplifier 110 and the output node Vout. In one embodiment, the miller compensation circuit 140 is coupled to the reference voltage V_{REF} side of the error amplifier 110.

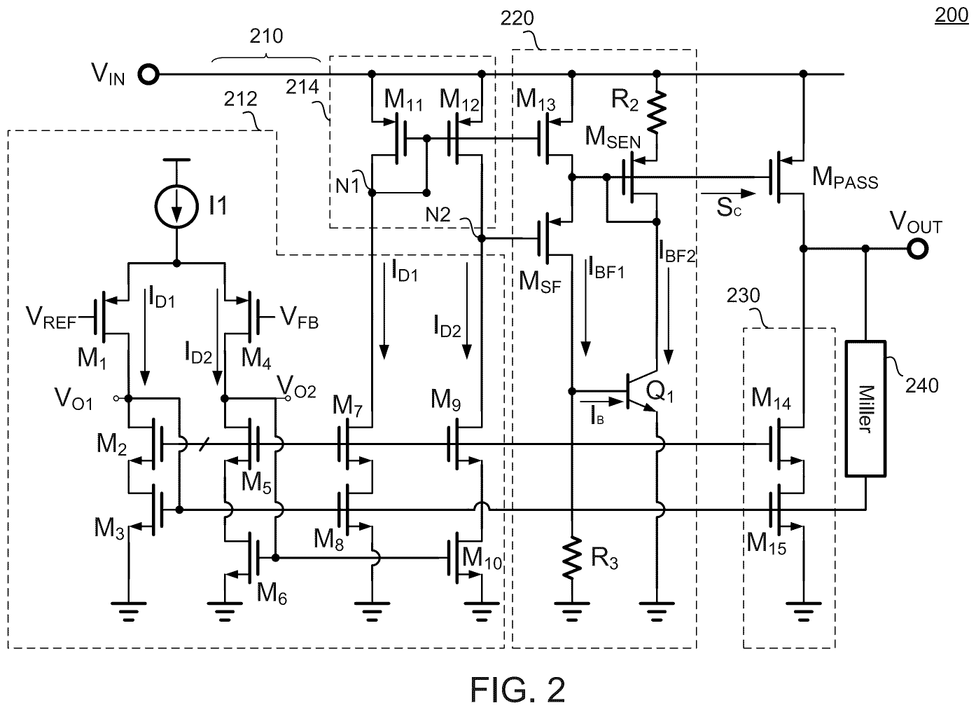

FIG. 2 is a schematic circuit diagram of an LDO circuit 200 in accordance with an embodiment of the present disclosure. The LDO circuit 200 includes an error amplifier 210, a buffer 220, a feed-forward loading stage 230, a miller compensation circuit 240, and a pass element M_{PASS}. In this embodiment, the error amplifier includes a first stage 212 and a current mirror stage 214. The first stage is configured to provide a first current signal I_{D1} to a first terminal N1 of the current mirror stage 214 in response to the reference voltage V_{REF}, and provide a second current signal I_{D2} to a second terminal N2 of the current mirror stage 214 in response to the feedback voltage V_{FB}.

For instance, the first stage 212 includes transistors M₁-M₁₀ and a current source I1 as shown in FIG. 1. A differential pair includes the transistors M₁ and M₄. The control terminal of the transistor M₁ forms the negative input terminal of the error amplifier 210 to receive the reference voltage V_{REF}, and the control terminal of the transistor M₄ forms the positive input terminal of the error amplifier 210 to receive the feedback voltage V_{FB}. The transistors M₂ and M₃ are coupled in series with the transistor M₁, and the transistors M₅ and M₆ are coupled in series with the transistor M₄. The first terminal (e.g., source) of the transistor M₂ is coupled to the second terminal (e.g., drain) of the transistor M₃. The second terminal (e.g., drain) of the transistor M₂ is coupled to the control terminal of the transistor M₃, and the control terminal (e.g., gate) of the transistor M₂ is coupled to the control terminal (e.g., gate) of the transistor M₅. The first terminal (e.g., source) of the transistor M₅ is coupled to the second terminal (e.g., drain) of the transistor M₆. The second terminal (e.g., drain) of the transistor M₅ is coupled to the control terminal of the transistor M₆. The transistors M₂, M₃, M₇, and M₈ form a current mirror. Specifically, the current mirror copies the current flowing through the transistor M₁ (i.e., the first current signal I_{D1}) at a first output terminal (e.g., V_{O1}) of the differential pair and provides the first current signal I_{D1} to a first terminal N1 of the current mirror stage 214. Similarly, the transistors M₅, M₆, M₉, and M₁₀ form a current mirror to provide the current flowing through the transistor M₄ (i.e., the second current signal I_{D2}) to a second terminal N2 of the current mirror stage 214. It should be noted that the current gain of the current mirror, that is, the ratio of the output current to the input current is ideally equal to 1. However, in some implementations, the ratio could be adjusted and determined by the width-length ratio of the transistors.

The current mirror stage 214 is implemented by two transistors M₁₁ and M₁₂. The transistors M₇ and M₈ are coupled in series with the transistor M₁₁, and the transistors M₉ and M₁₀ are coupled in series with the transistor M₁₂. In one embodiment, the pass element M_{PASS} is a P-type Metal-Oxide-Semiconductor Field-Effect Transistor (i.e., PMOS). In one implementation, the current mirror stage 214 is realized by the PMOS (i.e., M₁₁ and M₁₂) and is configured to receive the input voltage V_{IN}.

In one embodiment, the buffer 220 includes a first amplifier. The first amplifier serves as a source follower configured to buffer an input voltage and provide a lower impedance voltage. The first amplifier includes a transistor M_{SF}. The transistor M_{SF} is configured to receive the error signal (e.g., the voltage signal at the second terminal N2 of the current mirror stage 214), and provide a control signal Sc to the control terminal of the pass element M_{PASS}. The second terminal N2 of the current mirror stage 214 is the push-pull output coupled to the control terminal (e.g., gate) of the transistor M_{SF} to control the buffer 220. In one embodiment, a bipolar junction transistor (BJT) Q1 provides a feedback loop to further reduce the output impedance. Specifically, the control terminal (e.g., base) of the BJT Q1 is coupled to the second terminal (e.g., drain) of the transistor M_{SF}, and the second terminal (e.g., collector) of the BJT Q1 is coupled to the control terminal (e.g., gate) of the pass element M_{PASS}. In response to the current signal I_{B} (i.e., the base current of the BJT Q1), the output impedance can be further reduced by (1+β) times. It should be noted that, in some embodiments, the bipolar junction transistor (BJT) Q1 may be replaced by a MOSFET.

In one implementation, the first amplifier of the buffer 220 further includes a current source, coupled in series with the transistor M_{SF}. The current source is configured to provide a current signal to the transistor M_{SF}. In one embodiment, the current source is realized by the transistor M₁₃. The transistors M₁₃ and M_{SF} are coupled in series, and the transistors M₁₁ and M₁₃ form a PMOS mirror to set the minimum operating current I_{BF1} for the buffer 220. The control terminal (e.g., gate) of the transistor M_{SF} is coupled to the second terminal (e.g., drain) of the transistor M₁₂, and the second terminal (e.g., drain) of the transistor M_{SF} is coupled to the control terminal (e.g., base) of the BJT Q₁. With proper biasing scheme, the biasing current set by the PMOS mirror guarantees the BJT Q₁ performance and avoids the BJT Q₁ working at low-beta region. Moreover, the transistor M₁₃ further improves the transient performance. Specifically, when a transient event occurs, for example, from heavy load to light load, the output voltage increases. Therefore, the current flowing through the transistor M₄ (i.e., the second current signal I_{D2}) decreases as the feedback voltage V_{FB} increases, and thus the gate voltage of the transistor M_{SF} also increases. Meanwhile, the current flowing through the transistor M₁ (i.e., the first current signal I_{D1}) increases, and therefore the biasing current of the transistor M₁₃ also increases. As a result, the gate voltage of the pass element M_{PASS} also increases to make the output voltage at the output node V_{OUT} return to the target value.

In one implementation, the buffer 220 further includes a sensing transistor M_{SEN}. The sensing transistor M_{SEN} is coupled in series with the BJT Q₁. The control terminal (e.g., gate) of the transistor M_{SEN} is coupled to the first terminal (e.g., source) of the transistor M_{SF}, the second terminal (e.g., drain) of the transistor M_{SEN}, and the control terminal (e.g., gate) of the pass element M_{PASS}. The sensing transistor M_{SEN} is configured to monitor the operating condition (e.g., a loading current) of the pass element M_{PASS}. The biasing current I_{BF2} of the buffer 220 may be automatically adjusted with the transistor M_{SEN}.

In one embodiment, the buffer 220 further includes a resistor R₂ coupled in series with the transistor M_{SEN} to limit the biasing current I_{BF2} at light load. In another embodiment, the buffer 220 further includes a resistor R₃ coupled in series with the transistor M_{SF} to pull down the voltage level of the base of the BJT Q₁ for shutdown (standby) mode. That is, the BJT Q₁ is turned off. On the other hand, under light load condition, the BJT Q₁ is controlled to minimize the operating current, according to the operating current I_{BF1}, to achieve low quiescent current.

The feed-forward loading stage 230 includes a transistor (e.g., transistors M₁₄ and M₁₅). The transistors M₁₄ and M₁₅ are coupled in series with the pass element M_{PASS}. The control terminal (e.g., gate) of the transistor M₁₄ is coupled to the control terminal (e.g., gate) of the transistor M₂, and the control terminal (e.g., gate) of the transistor M₁₅ is coupled to the control terminal (e.g., gate) of the transistor M₃, and the second terminal (e.g., drain) of the transistor M₂. The transistors M₂, M₃, M₁₄, and M₁₅ form a current mirror to copy the current flowing through the transistor M₁ (i.e., the first current signal I_{D1}) and provide the loading current of the pass element M_{PASS}. That is, the feed-forward loading stage 230 is configured to adjust the loading current of the pass element M_{PASS} in response to information from the error amplifier 210. Specifically, when a transient event occurs, for example, from light load to heavy load, the output voltage drops. Therefore, the current flowing through the transistor M₄ (i.e., the second current signal I_{D2}) increases as the feedback voltage V_{FB} decreases, and thus the current flowing through the transistor M₁ (i.e., the first current signal I_{D1}) decreases. As a result, the current flowing through the transistors M₁₄ and M₁₅ also decreases such that the output voltage at the output node V_{OUT} can return to the target value easier and faster. Furthermore, the feed-forward loading stage 230 is further configured to avoid the pass element M_{PASS} to enter the fully off state during light load condition. This further minimizes the voltage dip when transient event happens, such as the high-frequency, periodic, and/or burst-type current profiles.

As shown in FIG. 2, the miller compensation circuit 240 is coupled between the error amplifier 210 on the V_{REF} side and the output node V_{OUT}. In one embodiment, the miller compensation circuit 240 includes a capacitor. Specifically, a first terminal of the capacitor is coupled to the first output terminal (e.g., V_{O1}) of the differential pair, which is the second terminal (e.g., drain) of the transistor M₂ and the control terminal (e.g., gate) of the transistor M₃. If there's any voltage change on the V_{OUT} node, the miller capacitor passes the fluctuation directly to the feed-forward loading stage 230. Thus, the loading current will be adjusted right immediately to against the change. Moreover, the main signal path (i.e., the feedback path) starts from the second current signal I_{D2} flowing through the second output terminal (e.g., V_{O2}) of the differential pair, through the current mirror for copying the second current signal I_{D2} and providing it to the second terminal N2 of the current mirror stage 214, to the control terminal of the pass element M_{PASS} through the transistor M_{SF}. We can find the feedback path now is free from the delay caused by charging and discharging the miller capacitor. Therefore, the slew rate will be faster than the conventional design. The error signal generated by the error amplifier 210 could be passed to the buffer 220 much faster and timely. Combine the two advantages above, the transient response can be extremely fast to overcome any change at the output node V_{OUT}.

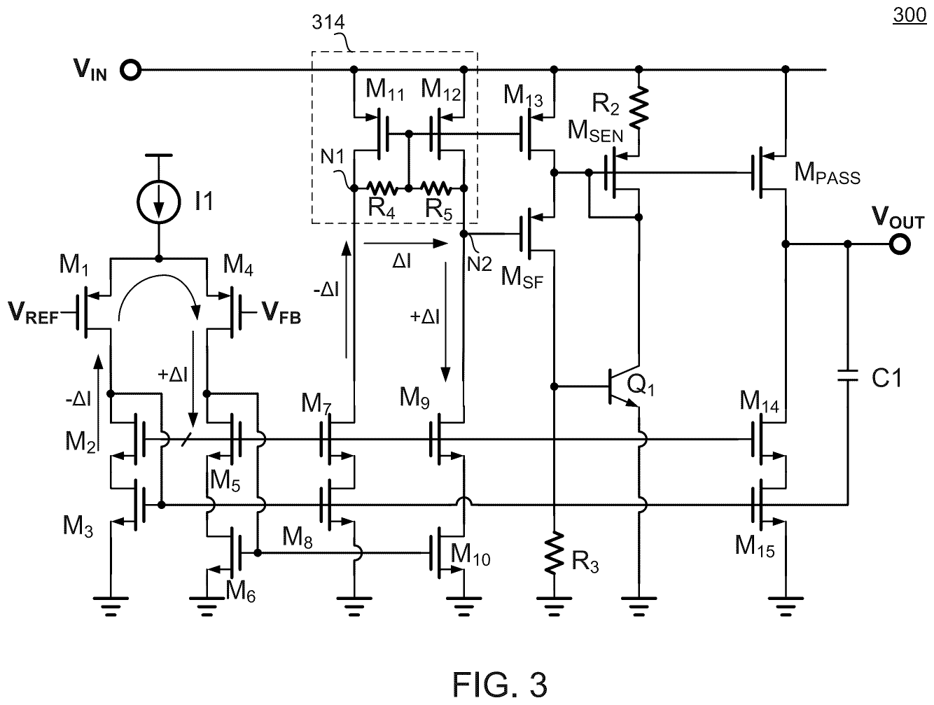

FIG. 3 is a schematic circuit diagram of an LDO circuit 300 in accordance with another embodiment of the present disclosure. In one embodiment, the current mirror stage 214 as shown in FIG. 2 is replaced by the improved current mirror 314 as shown in FIG. 3. The current mirror 314 further includes resistors R₄ and R₅. The resistors R₄ is coupled between the first terminal (e.g., drain) of the transistor M₁₁ and the control terminal (e.g., gate) of the transistor M₁₁. The resistors R₅ is coupled between the first terminal (e.g., drain) of the transistor M₁₂ and the control terminal (e.g., gate) of the transistor M₁₂. The second terminal (e.g., source) of the transistor M₁₁ and the second terminal (e.g., source) of the transistor M₁₂ are coupled together to receive the input voltage V_{IN}. The two resistors R₄ and R₅ connected to the both sides are used to bypass the huge gate capacitance during the transient event.

Specifically, when the output voltage at the output node V_{OUT} drops as the load current increases, the current flowing through the transistor M₄ increases (e.g., the second current signal I_{D2}+ΔI), and thus the current flowing through the transistor M₁ decreases (e.g., the first current signal I_{D1}−ΔI). Accordingly, the second current signal I_{D2} provided to the second terminal N2 of the current mirror stage 314 also increases (e.g., I_{D2}+ΔI) and the first current signal I_{D1} provided to a first terminal N1 of the current mirror stage 314 decreases (e.g., I_{D1}−ΔI). As a result, the current ΔI flows through the resistors R₄ and R₅. For a conventional current mirror, the current flowing through the transistor is controlled by the gate voltage, and therefore the transient response is slow due to charging and discharging the gate capacitance (e.g., the gate to source capacitance C_{GS}). With the two resistors R₄ and R₅, the current ΔI flows through the resistors R₄ and R₅ without charging the gate capacitor, and the error signal generated by the error amplifier may be passed to the buffer quickly. Therefore, faster transient performance could be achieved.

Meanwhile, when the output voltage at the output node V_{OUT} drops, the other terminal of the miller compensation circuit (e.g., a capacitor C1) that is connected to the control terminal of the transistors M₃, M₈, and M₁₅ also drops. In other words, the feed-forward loading stage (e.g., transistors M₁₄ and M₁₅) now draws less loading current from the output node V_{OUT}. Since the second current signal I_{D2} provided to the second terminal N2 of the current mirror stage 314 increases (e.g., I_{D2}+ΔI), the voltage level at the second terminal N2 of the current mirror stage 314 decreases, and therefore the transistor M_{SF} draws more current and the pass element M_{PASS} also draws more current. The voltage level of the control terminal (e.g., gate) of the pass element M_{PASS} will decrease. As a result, the pass element M_{PASS} provides more current to the output node V_{OUT}. With the two mechanism described above, fast transient response can be achieved.

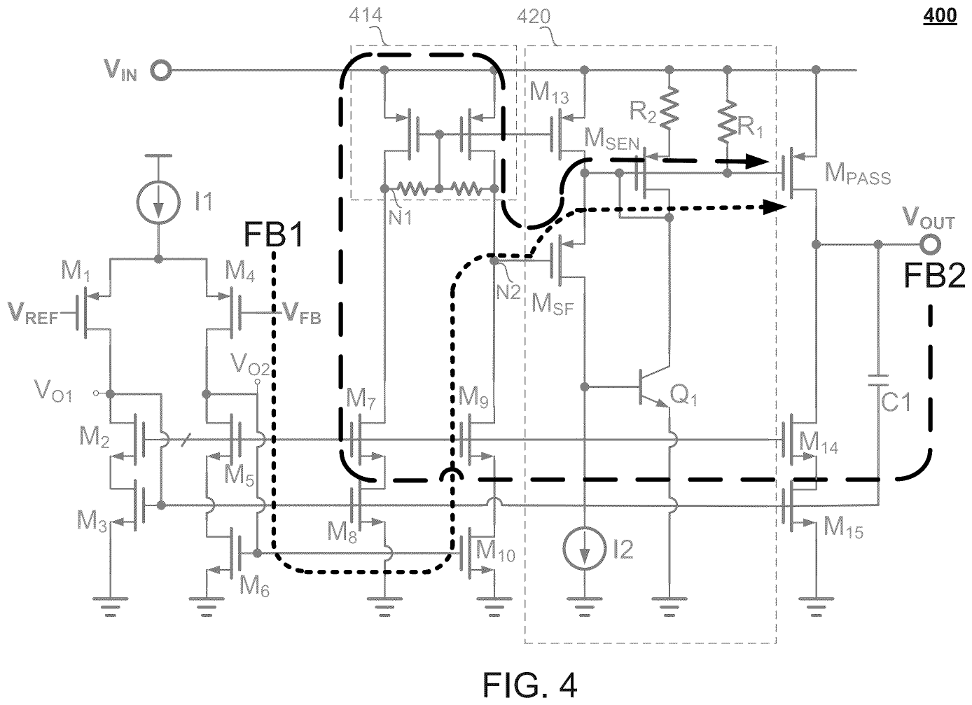

FIG. 4 is a schematic circuit diagram of an LDO circuit 400 in accordance with yet another embodiment of the present disclosure. As shown in FIG. 4, there are two feedback path to control the pass element M_{PASS}. The first feedback path FB1 starts from the differential pair of the error amplifier. Specifically, in response to the feedback voltage, the transistor M₄ provides the second current signal flowing through the second output terminal V_{O2} of the differential pair, and the second current signal is copied and provided to the second terminal N2 of the current mirror stage 414 through a second current mirror (e.g., formed by transistors M₅, M₆, M₉, and M₁₀), and then the first feedback path FB1 passes through the buffer (via the transistor M_{SF}) to the control terminal of the pass element M_{PASS}. On the other hand, the second feedback path FB2 starts from the output node Vout through the capacitor C1 to the control terminal of the transistor M₈ to provide the first current signal via the first current mirror (e.g., formed by transistors M₂, M₃, M₇, and M₈), and the first current signal is copied at the first terminal N1 of the current mirror stage 414 and provided to the second terminal N2 of the current mirror stage 414, and through the buffer to the control terminal of the pass element M_{PASS}.

In one embodiment, the resistor R₃ of the buffer 220 as shown in FIG. 2 is replaced by the reference current source I2. The reference current source I2 is coupled to a control terminal of the transistor Q1 to minimize the operating current of BJT Q1.

In another embodiment, the buffer circuit 420 further includes a resistor R₁ configured to pull up the gate of the transistor M_{SEN} for shutdown (standby) mode. That is, the transistor M_{SEN} is turned off to achieve low quiescent current.

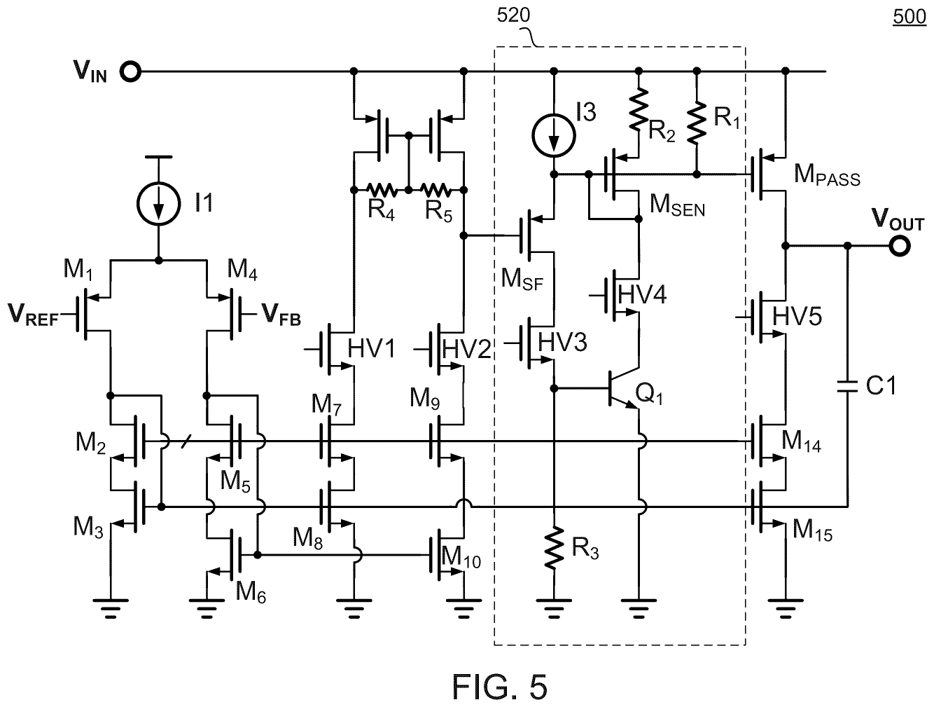

FIG. 5 is a schematic circuit diagram of an LDO circuit 500 in accordance with yet another embodiment of the present disclosure. In one embodiment, the transistor M₁₃ of the buffer 220 as shown in FIG. 2 is replaced by the current source I3. The current source I3 is configured to provide a current signal to the transistor M_{SF}.

In another embodiment, the LDO circuit 500 further includes high voltage switches HV1, HV2, HV3, HV4 and HV5 to withstand high voltage.

It should be understood that, the control circuit and the related components, circuit structures, signals, and waveforms described or shown above in the present disclosure are only for illustration purpose. However, the present disclosure is not limited thereto. Persons having ordinary skill in the art may understood that the control circuit of the present disclosure could be realized, according to practical applications, by any other circuits with different circuit structures, and thus controlled by different types of the corresponding signals to achieve the corresponding functions. For example, the compensation circuit, the ramp generation circuit, the comparison circuit and the logic circuit could be realized by a digital circuit, an analog circuit, a software, an automatic generation circuit by hardware description language, or a combination of the above.

It will be appreciated by persons skilled in the art that the present disclosure is not limited to what has been particularly shown and described herein above. Rather the scope of the present disclosure is defined by the claims and includes both combinations and sub-combinations of the various features described hereinabove as well as variations and modifications thereof which would occur to persons skilled in the art upon reading the foregoing description and which are not in the prior art.

What is claimed is:

1. A linear regulator circuit, comprising:
a pass element having a first terminal, a second terminal and a control terminal, wherein the first terminal of the pass element is configured to receive an input voltage, and the second terminal of the pass element is configured to provide an output voltage;
an error amplifier configured to provide an error signal to the control terminal of the pass element in response to a reference voltage and a feedback voltage representing the output voltage, wherein the error amplifier comprises:
a current mirror stage; and
a first stage coupled to the current mirror stage, wherein the first stage is configured to provide a first current signal to a first terminal of the current mirror stage in response to the reference voltage, and provide a second current signal to a second terminal of the current mirror stage in response to the feedback voltage;
a miller compensation circuit coupled between the second terminal of the pass element and the error amplifier, wherein the miller compensation circuit is configured to control the first current signal.

2. The linear regulator circuit of claim 1, wherein the first stage comprises:
a differential pair configured to receive the reference voltage and the feedback voltage;
a first current mirror coupled to a first output terminal of the differential pair and the first terminal of the current mirror stage; and
a second current mirror coupled to a second output terminal of the differential pair and the second terminal of the current mirror stage.

3. The linear regulator circuit of claim 1, wherein the current mirror stage comprises:
a current mirror circuit having a first transistor and a second transistor;
a first resistor coupled between a control terminal of the first transistor and a first terminal of the first transistor; and
a second resistor coupled between a control terminal of the second transistor and a first terminal of the second transistor.

4. The linear regulator circuit of claim 1, further comprises:
a buffer coupled between an output terminal of the error amplifier and the control terminal of the pass element.

5. The linear regulator circuit of claim 4, wherein the buffer comprises:
a first amplifier configured to provide a control signal to the control terminal of the pass element in response to the error signal from the current mirror stage; and
a transistor having a first terminal, a second terminal and a control terminal, wherein the control terminal of the transistor is coupled to the first amplifier, and the second terminal of the transistor is coupled to the control terminal of the pass element.

6. The linear regulator circuit of claim 4, wherein the buffer comprises:
a sensing transistor configured to sense a loading current of the pass element, and adjusting a biasing current.

7. The linear regulator circuit of claim 1, further comprises:
a feed-forward loading stage coupled between the error amplifier and the second terminal of the pass element, and configured to adjust a loading current of the pass element in response to the first current signal.

8. The linear regulator circuit of claim 7, wherein the feed-forward loading stage comprises:
a transistor coupled in series with the pass element.

9. A linear regulator circuit, comprising:
a pass element having a first terminal, a second terminal and a control terminal, wherein the first terminal of the pass element is configured to receive an input voltage, and the second terminal of the pass element is configured to provide an output voltage;
an error amplifier configured to provide an error signal in response to a reference voltage and a feedback voltage representing the output voltage; and
a buffer configured to provide a control signal to the control terminal of the pass element in response to the error signal, wherein the buffer comprises:
a first transistor having a first terminal, a second terminal and a control terminal, wherein the control terminal of the first transistor is configured to receive the error signal, and the first terminal of the first transistor is coupled to the control terminal of the pass element;
a second transistor having a first terminal, a second terminal and a control terminal, wherein the control terminal of the second transistor is coupled to the second terminal of the first transistor, and the second terminal of the second transistor is coupled to the control terminal of the pass element; and
a current source, coupled in series with the first transistor, configured to provide a current signal to the first transistor.

10. The linear regulator circuit of claim 9, wherein the current source comprises:
a third transistor configured to set an operating current for the buffer.

11. The linear regulator circuit of claim 9, wherein the buffer further comprises:
a sensing transistor configured to sense a loading current of the pass element, and adjust a biasing current of the second transistor.

12. The linear regulator circuit of claim 11, wherein the buffer further comprises:
a first resistor coupled in series with the sensing transistor.

13. The linear regulator circuit of claim 11, wherein the buffer further comprises:
a second resistor coupled to a control terminal of the sensing transistor.

14. The linear regulator circuit of claim 9, wherein the buffer further comprises:
a third resistor coupled to a control terminal of the second transistor.

15. The linear regulator circuit of claim 9, wherein the buffer further comprises:
a reference current source coupled to a control terminal of the second transistor.

16. The linear regulator circuit of claim 9, wherein the error amplifier comprises:
a current mirror stage configured to receive the input voltage; and
a first stage coupled to the current mirror stage, wherein the first stage is configured to provide a first current signal to a first terminal of the current mirror stage in response to the reference voltage, and provide a second current signal to a second terminal of the current mirror stage in response to the feedback voltage;
wherein the buffer further comprises:
a third transistor coupled in series with the first transistor, wherein a control terminal of the third transistor is coupled to the first terminal of the current mirror stage, wherein third transistor is configured to provide a current signal to the first transistor in response to the first current signal.

17. The linear regulator circuit of claim 16, further comprises:
a miller compensation circuit coupled between the second terminal of the pass element and the error amplifier, wherein the miller compensation circuit is configured to control the first current signal.

18. The linear regulator circuit of claim 9, further comprises:
a feed-forward loading stage coupled between the error amplifier and the second terminal of the pass element, and configured to adjust a loading current of the pass element in response to the first current signal.

19. A linear regulator circuit, comprises:
a pass element having a first terminal, a second terminal and a control terminal, wherein the first terminal of the pass element is configured to receive an input voltage, and the second terminal of the pass element is configured to provide an output voltage;
an error amplifier comprising a differential pair configured to provide a first current signal at a first output terminal in response to a reference voltage and provide a second current signal at a second output terminal in response to a feedback voltage representing the output voltage, wherein the error amplifier is configured to provide an error signal in response to the reference voltage and the feedback voltage;
a buffer configured to provide a control signal to the control terminal of the pass element in response to the error signal;
a feed-forward loading stage coupled between the error amplifier and the second terminal of the pass element, wherein the feed-forward loading stage is configured to adjust a loading current of the pass element; and
a miller compensation circuit coupled between the second terminal of the pass element and the error amplifier;
wherein the pass element is controlled in response to the control signal via a first feedback path, wherein the first feedback path starts from the second current signal flowing through the second output terminal of the differential pair, through a first current mirror coupled to the second output terminal of the differential pair, and through the buffer to the control terminal of the pass element.

20. The linear regulator circuit of claim 19, wherein the error amplifier further comprises:
a current mirror stage configured to receive the input voltage and provide the error signal to the buffer; and
a second current mirror coupled to the first output terminal of the differential pair and a first terminal of the current mirror stage;
wherein the miller compensation circuit includes a capacitor coupled between the second terminal of the pass element and the first output terminal;
wherein the pass element is controlled in response to the control signal via a second feedback path, wherein the second feedback path starts from an output node through the capacitor to a control terminal of a transistor to provide the first current signal, through the current mirror stage, and through the buffer to the control terminal of the pass element.

21. The linear regulator circuit of claim 19, wherein the feed-forward loading stage comprises:
a transistor, coupled in series with the pass element, configured to adjust a loading current of the pass element in response to the first current signal.

22. The linear regulator circuit of claim 19, wherein the buffer comprises:
a first transistor having a first terminal, a second terminal and a control terminal, wherein the control terminal of the first transistor is configured to receive the error signal, and the first terminal of the first transistor is coupled to the control terminal of the pass element;
a second transistor having a first terminal, a second terminal and a control terminal, wherein the control terminal of the second transistor is coupled to the second terminal of the first transistor, and the second terminal of the second transistor is coupled to the control terminal of the pass element; and
a current source, coupled in series with the first transistor, configured to provide a current signal.

23. The linear regulator circuit of claim 22, wherein the buffer further comprises:
a sensing transistor configured to sense a loading current of the pass element, and adjust a biasing current of the second transistor.
